(19) United States
(12) Patent Application Publication
(10) Pub. No.: US 2011/0188155 A1
(43) Pub. Date: Aug. 4, 2011

(54) METHOD OF COMPENSATING FOR IMBALANCE OF HARD DISK DRIVE, APPARATUS TO PERFORM COMPENSATION, AND HARD DISK DRIVE MANUFACTURED THEREBY

(75) Inventors: Joon-Young Lee, Suwon-si (KR); Young Bae Chang, Seoul (KR); Cheol-Soon Kim, Anyang-si (KR); Kyung Ho Kim, Seoul (KR)

(73) Assignee: Samsung Electronics Co., Ltd, Suwon-si (KR)

(21) Appl. No.: 13/017,517

(22) Filed: Jan. 31, 2011

(30) Foreign Application Priority Data
Feb. 1, 2010 (KR) 2010-9301

(51) Int. Cl. G11B 17/022; G11B 17/035

(52) U.S. Cl. 360/98.08; 360/98.01; G9B/17.003; G9B/17.011

(57) ABSTRACT

A method of compensating for an imbalance of a hard disk drive includes biasing a plurality of disks in one direction with respect to a rotational shaft of a spindle motor hub, measuring an amount of imbalance of the plurality of disks with respect to the rotational shaft of the spindle motor hub, and compensating the amount of imbalance of the plurality of disks by hitting the hard disk drive in the opposite direction to the one direction in which the plurality of disks are biased to reduce the amount of imbalance with an amount of impact predetermined based on a measured imbalance amount.

### CROSS-REFERENCE TO RELATED APPLICATIONS

This application claims the benefit of priority under 35 U.S.C. §119(a) to Korean Patent Application No. 10-2010-0009301 filed on Feb. 1, 2010, in the Korean Intellectual Property Office, the disclosure of which is incorporated herein in its entirety by reference.

### BACKGROUND

1. Field of the Invention

The present general inventive concept relates to a method of compensating for imbalance of a hard disk drive (HDD) and an HDD manufactured by the method, and more particularly, to a method of compensating for the amount of imbalance of an HDD by applying an impact to the HDD, and an HDD manufactured by the method.

2. Description of the Related Art

Hard disk drives (HDDs) are memory devices formed of electronic apparatuses and mechanical apparatuses for recording and reproducing data by converting a digital electronic pulse into a permanent magnetic field. The HDD is widely used as an auxiliary memory device for a computer system because it can access a large amount of data at high speed.

The HDD may include a disk stack assembly having a disk for recording and storing data, a head stack assembly (HSA) for reading out data from the disk by pivoting across the disk around a predetermined pivot shaft, a printed circuit board assembly (PCBA) for controlling the above constituent elements by using most circuit parts mounted on a printed circuit board (PCB), a base on which the above constituent elements are assembled, and a cover to cover the base.

An amount of imbalance in a rotating system such as a head stack assembly or a disk stack assembly may be generated by eccentrically distributed mass of a rotary body with respect to the rotation center thereof. The imbalance generates vibrations and noise during rotation. In a disk stack assembly, the eccentricity of a disk may damage a ball bearing or a fluid bearing of a spindle motor so that reliability of an HDD may be deteriorated.

Although there are various causes of imbalance in a disk stack assembly, due to tolerance of constituent elements such as a spindle motor, a disk, or a spacer constituting the disk stack assembly, the rotation of each center of the constituent elements does not match the weight center to the rotation center of assembled constituent elements so that imbalance may be generated due to the eccentricity.

Many studies on the technologies to improve the imbalance of a disk stack assembly have been performed and some of the technologies are introduced herein.

Methods of compensating for imbalance of a disk stack assembly include a static imbalance correction method and a dynamic imbalance correction method. In the static imbalance correction method, imbalance with respect to a single plane is measured, and geometrical biases are intentionally offset by adding counter mass or biasing a disk and a spacer in the opposite directions, so that the amount of imbalance may be minimized. In the dynamic imbalance correction method, imbalance positions of a plurality of disks which are different from one another are approached in circumferential directions of the disks by applying an impact to the HDD. Then, an impact is applied to an HDD in the opposite direction to the imbalance positions of each of the disks so that the approached imbalance positions may move in a radial direction of a disk with respect to the rotation center of a rotation shaft of a hub. Thus, the amount of imbalance may be corrected.

However, in the static imbalance correction method, since the repeatable run out (RRO) of a vibration frequency is extended from 1× to n× due to the geometric bias, it is difficult to overcome the imbalance by servo control as track per inch (TPI) increases. Also, even when the geometric biases are offset with one another by the static imbalance correction method, a large internal imbalance of a spindle motor may not be overcome.

Thus, in an HDD requiring a large capacity and fast read/write performance, it may be difficult to compensate for a large imbalance by the static imbalance correction method to manufacture precise rotary bodies.

In addition, there are the following two basic problems in the dynamic imbalance correction method that is a more suitable method for manufacturing high precise rotary bodies.

First, the imbalance positions of the disks that are different from one another in the circumferential direction of a disk cause an HDD that is a body to be compensated to have a different characteristic. Also, the imbalance positions of the disks that are different from one another need to be brought closer to one another by applying an impact to the HDD. In the process, since an unnecessary impact having a little compensation effect may be applied to the HDD, more time is needed for the imbalance compensation process.

Second, to measure the amount of imbalance of a body to be compensated, such as an HDD, and to compensate for the amount of imbalance, in a process of calculating an amount of impact to be applied to an HDD to compensate for the amount of imbalance calculated based on acceleration of a plurality of disks detected by an HDD imbalance compensation apparatus, an absolute amount of impact corresponding to the amount of imbalance is calculated and an impact is applied based on the calculated amount even though each disk has a different friction characteristic due to a difference in tolerance and environment of parts constituting a rotary body of each body to be compensated during mass production. Thus, the amount of impact applied to the HDD that is a body to be compensated may be too small and may generate only a small imbalance compensation effect so that an intended change may not be obtained. That is, an imbalance stagnation phenomenon may occur. On the other hand, if too large of an impact is applied, the amount of imbalance may increase further, and an imbalance divergence phenomenon may frequently occur.

Since the same level of an impact is applied each time in the compensation of imbalance of an HDD that is a body to be compensated even when a characteristic of imbalance of each HDD being decreased is different, the above phenomena bring about an extended time to compensate for imbalance. In an extreme case, the compensation for imbalance fails so that mass production of HDDs may become difficult.

### SUMMARY

The present general inventive concept provides a method of compensating for imbalance of a hard disk drive (HDD) which may reduce unnecessary application of an impact during the compensation of the imbalance of an HDD so that a tact time may decrease and the method may be applied to mass production. The present general inventive concept also provides an HDD manufactured by the method.

The present general inventive concept also provides a method of compensating for imbalance of an HDD which may compensate for imbalance according to the characteristic of each HDD so that a high compensation success rate and a reduced process time may be obtained and the method may be applied to mass production, and an HDD manufactured by the method.

Additional aspects and utilities of the present general inventive concept will be set forth in part in the description which follows and, in part, will be obvious from the description, or may be learned by practice of the present general inventive concept.

Features and/or utilities of the present general inventive concept may be realized by a method of compensating for the imbalance of a hard disk drive including biasing a plurality of disks in one direction with respect to a rotational shaft of a spindle motor hub, the plurality of disks being mounted on the spindle motor hub to rotate a disk of a hard disk drive, measuring an amount of imbalance of the plurality of disks that are biased with respect to the rotational shaft of the spindle motor hub, and compensating the amount of imbalance of the plurality of disks by hitting the hard disk drive in the opposite direction to the one direction in which the plurality of disks are biased to reduce the amount of imbalance with an amount of impact predetermined based on a measured imbalance amount.

The compensating of the amount of imbalance of the plurality of disks may include hitting the hard disk drive with an amount of impact predetermined based the measured imbalance amount (a regular compensation operation), and measuring an amount of imbalance after the hitting of the hard disk drive and hitting the hard disk drive with an amount of impact predetermined based on an amount of a change in the amount of imbalance before and after the hitting (an adaptive compensation operation).

In the regular compensation operation, the amount of impact to hit the hard disk drive may be determined according to an impact amount reference lookup table containing values predetermined corresponding to the amount of imbalance.

The adaptive compensation operation may include determining whether it is a divergence case in which the amount of imbalance increases after the hitting than before the hitting or a stagnation case in which the amount of imbalance decreases after the hitting than before the hitting, and the hard disk drive may be hit again with an amount of impact previously set according to the divergence case, the stagnation case, or a degree of the stagnation case.

The hard disk drive may be hit with an amount of impact of the impact amount reference lookup table shifted from the impact amount reference lookup table according to an adaptive lookup table containing a level to be shifted from the impact amount reference lookup table according to the divergence case, the stagnation case, or a degree of the stagnation case.

In the stagnation case, the adaptive compensation operation may be repeatedly performed until the amount of imbalance reaches a target imbalance amount or a predetermined frequency is reached.

In the divergence case, the hard disk drive may be repeatedly hit with the amount of impact of the impact amount reference lookup table shifted from the impact amount reference lookup table according to the adaptive lookup table until the amount of imbalance reaches a target imbalance amount or a predetermined frequency is reached.

Features and/or utilities of the present general inventive concept may also be realized by a method of compensating imbalance of a hard disk drive, which includes measuring an amount of imbalance of a plurality of disks with respect to a rotational shaft of a spindle motor hub, the plurality of disks being mounted on the spindle motor hub to rotate a disk of a hard disk drive, hitting the hard disk drive with an amount of impact predetermined based a measured imbalance amount (a regular compensation operation), and measuring an amount of imbalance after the hitting of the hard disk drive and hitting the hard disk drive with an amount of impact predetermined based on an amount of a change in the amount of imbalance before and after the hitting (an adaptive compensation operation).

In the regular compensation operation, the amount of impact to hit the hard disk drive may be determined according to an impact amount reference lookup table containing values predetermined corresponding to the amount of imbalance.

The adaptive compensation operation may include determining whether it is a divergence case in which the amount of imbalance increases after the hitting than before the hitting or a stagnation case in which the amount of imbalance decreases after the hitting than before the hitting, and the hard disk drive may be hit again with an amount of impact previously set according to the divergence case, the stagnation case, or a degree of the stagnation case.

The hard disk drive may be hit with an amount of impact of the impact amount reference lookup table shifted from the impact amount reference lookup table according to an adaptive lookup table containing a level to be shifted from the impact amount reference lookup table according to the divergence case, the stagnation case, or a degree of the stagnation case.

In the stagnation case, the adaptive compensation operation may be repeatedly performed until the amount of imbalance reaches a target imbalance amount or a predetermined frequency is reached.

In the divergence case, the hard disk drive may be repeatedly hit with the amount of impact of the impact amount reference lookup table shifted from the impact amount reference lookup table according to the adaptive lookup table until the amount of imbalance reaches a target imbalance amount or a predetermined frequency is reached.

Features and/or utilities of the present general inventive concept may also be realized by a hard disk drive which includes a spindle motor hub provided on a base, and a plurality of disks mounted on the spindle motor hub and on which a scratch pattern is formed in the same direction.

Features and/or utilities of the present general inventive concept may also be realized by a method of compensating for an imbalance of disks of a hard disk drive, the method including measuring an imbalance of the disks of the hard disk drive, applying a jolting force to the hard disk drive based on the measured imbalance, measuring a change in imbalance after applying the jolting force to the hard disk drive, the change being a difference between the imbalance before applying the jolting force and the imbalance after applying the jolting force, calculating an adaptive jolting force to apply to the hard disk drive based on the measured change in imbalance, and applying the adaptive jolting force to the hard disk drive.

The method may include, before measuring the imbalance of the disks, biasing each of the disks in the same direction with respect to a spindle motor hub on which the disks are mounted.

Measuring the imbalance of the disks may include rotating the disks and detecting the imbalance of the rotating disks.

Applying the jolting force may include accessing a table having a plurality of imbalance ranges and a plurality of corresponding jolting forces, matching the measured imbalance with one of the plurality of imbalance ranges, and applying the corresponding jolting force.

Measuring the change in imbalance after applying the jolting force may include applying the following formula:

imbalance before applying lofting force−imbalance after applying jolting force lower limit of matched one of the plurality of imbalance ranges.

Calculating the adaptive jolting force may include accessing an adaptive jolting force table including a plurality of ranges of change in imbalance and a corresponding plurality of adjustment values, matching the measured change in imbalance with one of the plurality of ranges, and applying the corresponding adjustment value to the jolting force to generate an adaptive jolting force.

Applying the adaptive jolting force to the hard disk drive may include repeatedly applying the adaptive jolting force to the hard disk drive and measuring the imbalance of the hard disk drive until the measured imbalance is within a target range.

The adaptive jolting force may be repeatedly applied to the hard disk drive without re-calculating the adaptive jolting force.

Features and/or utilities of the present general inventive concept may also be realized by a hard disk drive imbalance compensation device including a detection unit to detect an imbalance of a hard disk drive, a jolt force application unit to apply a jolting force to the hard disk drive, and a control unit to control the detection unit to detect the imbalance of the hard disk drive, to control the jolt force application unit to apply a jolting force to the hard disk drive based on the detected imbalance, to calculate a change in imbalance after the jolting force is applied, to calculate an adaptive jolting force to apply to the hard disk drive, and to control the jolt force application unit to apply the adaptive jolting force.

The control unit may include a memory to store a jolting force table, and the control unit may determine a jolting force to apply to the hard disk drive based on a value stored in the jolting force table that corresponds to the detected imbalance of the hard disk drive.

The control unit may include a memory to store an adaptive jolting force table, and the control unit may determine an adaptive jolting force to apply to the hard disk drive based on a value stored in the jolting force table that corresponds to the calculated change in imbalance of the hard disk drive.

The control unit may calculate the adaptive jolting force by applying the value stored in the jolting force table to the jolting force to generate the adaptive jolting force.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 is a perspective view of an HDD employing a method of compensating for an imbalance of the HDD according to an exemplary embodiment of the present general inventive concept;

FIG. 2 is a cross-sectional view of a disk stack assembly of the HDD of FIG. 1;

FIG. 3 is a perspective view of an HDD imbalance compensation apparatus used for a method of compensating for the imbalance of the HDD according to an exemplary embodiment of the present general inventive concept;

FIG. 4 is a perspective view of a major portion of an impact application unit of the HDD imbalance compensation apparatus of FIG. 3;

FIG. 5 is a plan view of a main frame of the HDD imbalance compensation apparatus of FIG. 3;

FIGS. 6A and 6B are flowcharts to illustrate a method of compensating for an imbalance of an HDD according to an exemplary embodiment of the present general inventive concept;

FIGS. 7A-7D an operation of biasing a plurality of disks in one direction and applying a force to the disks to compensate for an imbalance;

FIG. 8 schematically illustrates an operation of compensating for the amount of imbalance by applying an impact to an HDD in the opposite direction to the imbalance positions of the disks; and

FIG. 9 illustrates an HDD imbalance compensation system or device according to an embodiment of the present general inventive concept.

### DETAILED DESCRIPTION OF THE EMBODIMENTS

The attached drawings for illustrating embodiments of the present general inventive concept are referred to in order to gain a sufficient understanding of the inventive concept and the merits thereof. Hereinafter, the inventive concept will be described in detail by explaining embodiments of the inventive concept with reference to the attached drawings. Like reference numerals in the drawings denote like elements.

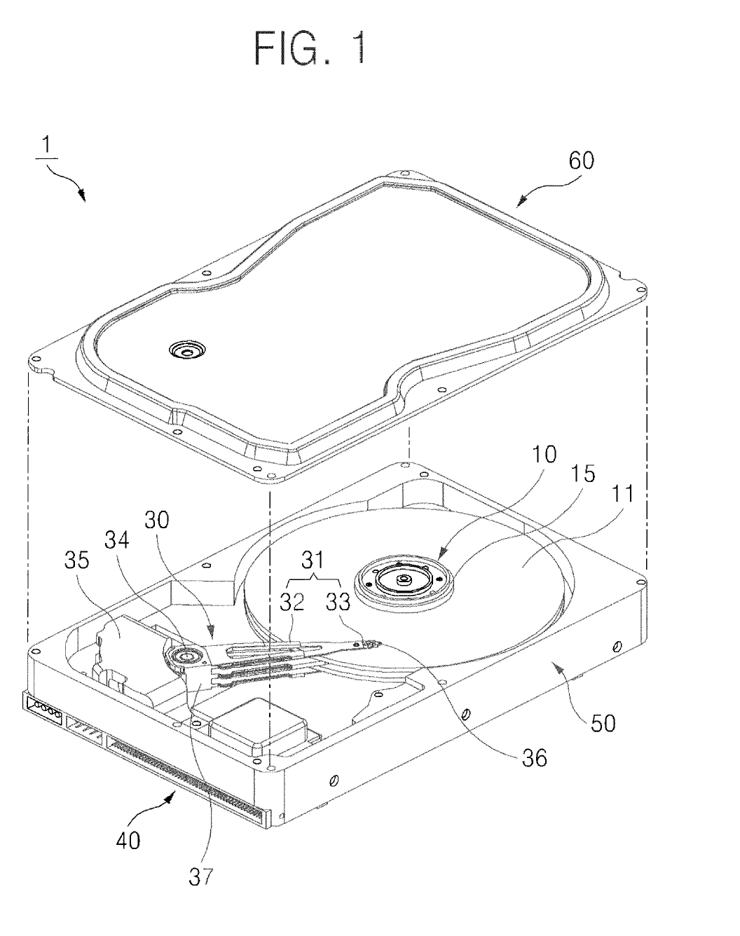

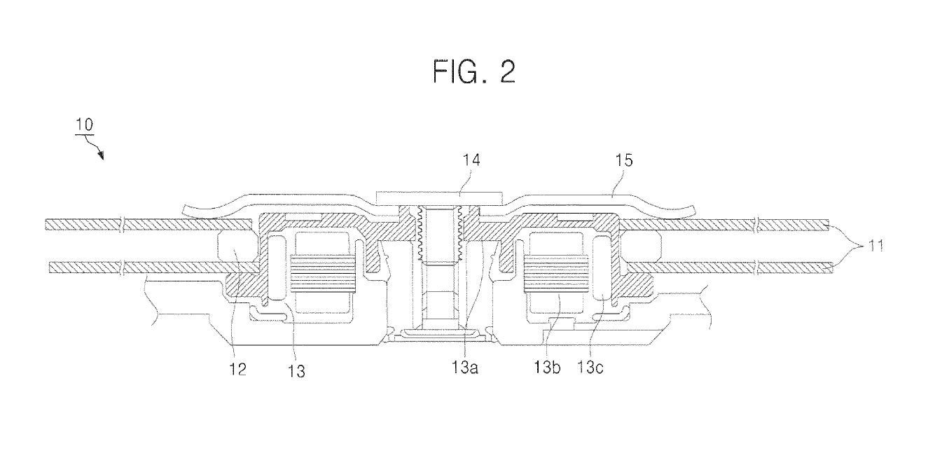

FIG. 1 is a perspective view of an HDD 1 employing a method for compensating imbalance of the HDD 1 according to an exemplary embodiment of the present general inventive concept. FIG. 2 is a cross-sectional view of a disk stack assembly of the HDD 1 of FIG. 1.

Referring to FIGS. 1 and 2, the HDD 1 may include a disk stack assembly 10 having a disk 11 to record and store data, a head stack assembly (HSA) 30 on which a head 36 for reading out data from the disk by pivoting across the disk 11 around a predetermined pivot shaft 34 is installed, a printed circuit board assembly (PCBA) 40 to control the above constituent elements by using circuit parts mounted on a printed circuit board (PCB), a base 50 on which the above constituent elements are assembled, and a cover 60 to cover the base 50.

In the HDD 1 configured as above, when a recording or reproduction operation starts, the head 36 is moved to a predetermined position on the disk 11 that is rotating, to perform the recording or reproduction.

The HSA 30 includes an actuator arm 31 to move the head 36 to access data on the disk 11, the pivot shaft holder 34 rotatably supporting the pivot shaft 37, to which the actuator arm 31 is coupled by being supported thereon, and a bobbin (not shown) with a voice coil motor (VCM) coil wound therearound extending from the pivot shaft holder 34 in the opposite direction to the actuator arm 31 and disposed between magnets of the VCM 35.

The actuator arm 31 may be divided into a swing arm 32 rotating around the pivot shaft holder 34 by the VCM and a suspension 33 supported on the swing arm 32 and having the head 36 mounted at a leading end thereof.

The VCM 35 is a type of a drive motor to pivot the actuator arm 31 to move the head 36 to a desired position on the disk 11. The VCM 35 is operated according to the Fleming's left hand rule, that is, a force is generated when current flows in a conductive body existing in a magnetic field. By applying current to the VCM coil existing between the magnets, a force is applied to the bobbin to pivot the bobbin.

Accordingly, the actuator arm 31 extending from the pivot shaft holder 37 in the opposite direction to the bobbin pivots so that the head 36 supported on an end portion thereof may search tracks and access information by moving in the radial direction of the disk 11 that is rotating and may process accessed information.

The disk stack assembly 10 for the rotation of the disk 11 includes a plurality of disks 11 to record and store data, a spindle motor 13 having a spindle motor hub 13a to support the disks 11 and to rotate the disks 11, and a clamp 15 to fix the disks 11 to the spindle motor hub 13a by elastically pressing the disks 11 when a clamp screw 14 is coupled to the spindle motor hub 13a.

As the clamp screw 14 is screw coupled to the spindle motor hub 13a, the clamp screw 14 presses an inner edge portion of the clamp 15. Accordingly, an outer edge portion of the clamp 15 elastically presses the disks 11 so that the disks 11 arranged with a spacer 12 interposed between the disks 11 are fixed to the spindle motor hub 13a.

In the HDD 1 configured as above, the disks 11 fixed to the spindle motor hub 13a are rotated together with the spindle motor hub 13a according to the rotation of the spindle motor hub 13a. That is, an electromagnetic force is generated by interaction between a stator core 13b and a magnet 13c installed on the spindle motor hub 13a. A generated electromagnetic force rotates the spindle motor hub 13a, and thus, the disks 11 fixed on the spindle motor hub 13a are rotated at the same time.

In the HDD 1 according to the present exemplary embodiment, a scratch pattern is formed on the disks 11 in the same direction. The scratch pattern formed on the disks 11 in the same direction is generated because bias is first applied to the disks 11 in one direction to make the disks 11 aligned at a side before an impact is applied to the HDD 1 to compensate for an imbalance, and then an impact is applied to the disks 11 in the opposite direction, according to the method of compensating for an imbalance of an HDD according to the present exemplary embodiment which will be described later.

An imbalance compensation apparatus used to compensate for imbalance of an HDD will be schematically described and then a method for compensating imbalance of an HDD according to an exemplary embodiment will be describe in detail.

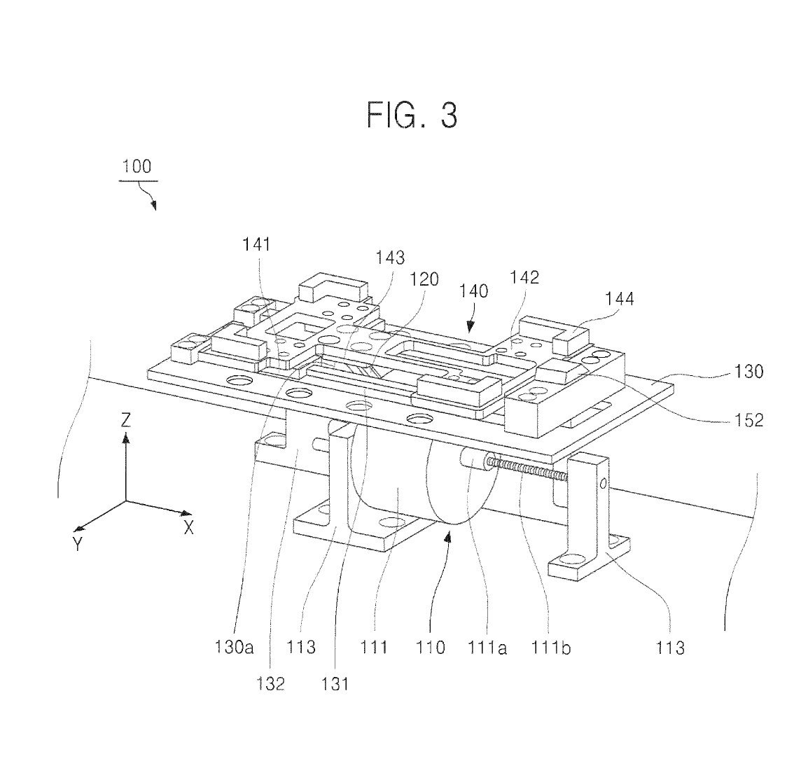

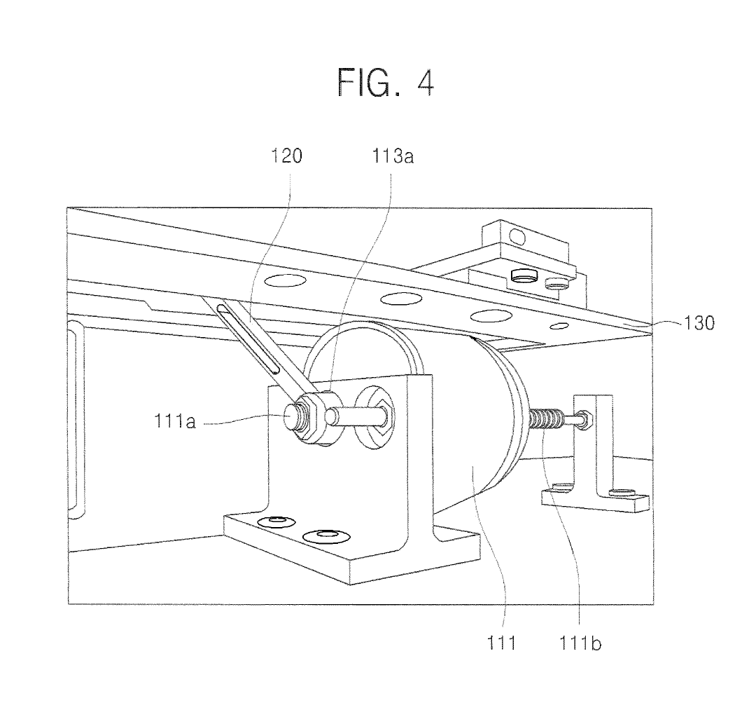

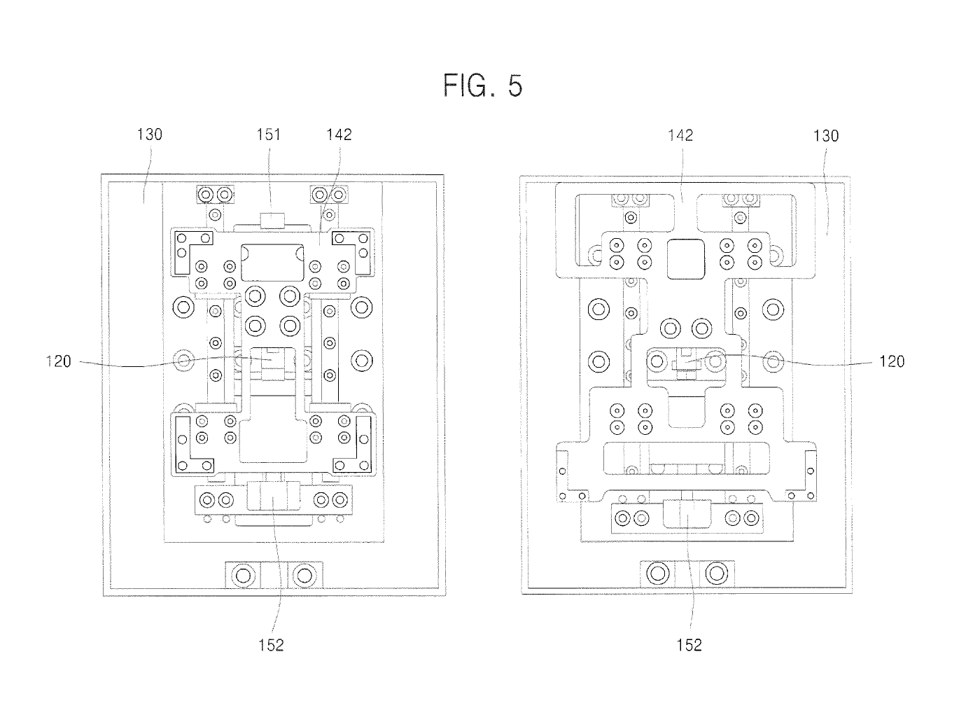

FIG. 3 is a perspective view of an HDD imbalance compensation apparatus 100 used for a method of compensating for an imbalance of the HDD according to an exemplary embodiment of the present general inventive concept. FIG. 4 is a perspective view of a major portion of an impact application unit of the HDD imbalance compensation apparatus 100 of FIG. 3. FIG. 5 is a plan view of a main frame of the HDD imbalance compensation apparatus 100 of FIG. 3.

Referring to FIGS. 3-5, the HDD imbalance compensation apparatus 100 according to the present exemplary embodiment includes an impact application unit 110, a fixed frame 130, a movable frame 140, an acceleration detection unit 150, and a control unit (not shown).

The impact application unit 110 generates an impact to compensate for the amount of imbalance of the disks 11 biased in one direction. The impact application unit 110 includes a solenoid 111 having a movable steel core 111a, a spring 111b to return the movable steel core 111a to the original position after an impact is applied to the HDD, and a column 113 to support the solenoid 111 from the ground or a fixed surface.

Throughout the specification and claims, the terms impact, hitting, contact force, and jolting force all refer to the sudden application of force to the hard disk drive 1, by the HDD imbalance compensation apparatus 100, for example. It should be understood that any similar term may be used according to the understanding of one of ordinary skill in the art in light of the disclosure of the present specification.

As it is well known, when energy is supplied to a coil (not shown) provided in the solenoid 111, the movable steel core 111a is moved by a magnetic attraction force that is generated in the coil. The amount of movement of the magnetic attraction force is proportional to the amount of the supplied energy.

That is, when the amount of the energy supplied to the solenoid 111 is large, the amount of the movement of the movable steel core 111a increases accordingly. The spring 111b is coupled to an end portion of the movable steel core 111a and returns the movable steel core 111a to the original position after an impact by the movable steel core 111a is applied to the HDD.

The impact application unit 110 further includes a connection member 120 to transfer an impact applied by the solenoid 111 to the movable frame 140. While one end portion of the connection member 120 is coupled to one end portion of the movable steel core 111a, the other end portion of the connection member 120 is coupled to a connection member coupling plate 143 provided on the movable frame 140. When the impact application unit 110 applies an impact to the HDD, the connection member 120 coupled to one end portion of the movable steel core 111a is moved. Accordingly, the movable frame 140 coupled to the one end portion of the connection member 120 is relatively moved with respect to the fixed frame 130 along a guide rail 131 provided on an upper surface of the fixed frame 130.

The fixed frame 130 is provided between the impact application unit 110 and the movable frame 140, supported from the ground by the column 132, and includes the guide rail 131 arranged on the upper surface thereof. The fixed frame 130 separates the impact application unit 110 and the movable frame 140 from each other. The guide rail 131 guides movement of the movable frame 140 and is provided by a pair at both sides of the upper surface of the fixed frame 130.

The movable frame 140 includes a guide rail coupling unit 141 having a shape corresponding to the guide rail 131 of the fixed frame 130, a main frame 142 on which the HDD 1 is mounted, a connection member coupling plate 143 coupled to a lower surface of the main frame 142, and a bracket 144 provided at each end portion of the main frame 142.

The bracket 144 fixed at each end portion of the main frame 142 prevents movement of the HDD 1 mounted on the main frame 142. When the impact application unit 110 applies an impact to the HDD 1, the main frame 142 relatively moves with respect to the guide rail 131. However, since the HDD 1 is fixed by the bracket 144, only the disks 11 forming the HDD 1 slip so that the amount of imbalance of the disks 11 may be compensated.

The HDD imbalance compensation apparatus 100 of the present exemplary embodiment further includes the acceleration detection unit. The acceleration detection unit detects the acceleration of each of the disks 11 of the HDD 1 to produce the amount of imbalance and includes a first detection unit 152 and a second detection unit 151.

The first detection unit 152 is coupled to one side portion of the fixed frame 130 to detect acceleration according to the rotation of the disks 11. The second detection unit 151 is coupled to the fixed frame 130 at a location corresponding to the side of the fixed frame 130 opposite the first detection unit 152 and is connected to the movable frame 140 to measure a force generated due to the imbalance of the disks 11.

The control unit calculates the amount of impact, or an intensity of a contact force, according to the amount of imbalance according to an impact amount reference lookup table or an impact amount reference lookup table and an adaptive lookup table which will be described later, and controls the impact application unit 110 to hit the HDD 1 with the calculated amount of impact, or a calculated intensity of contact force.

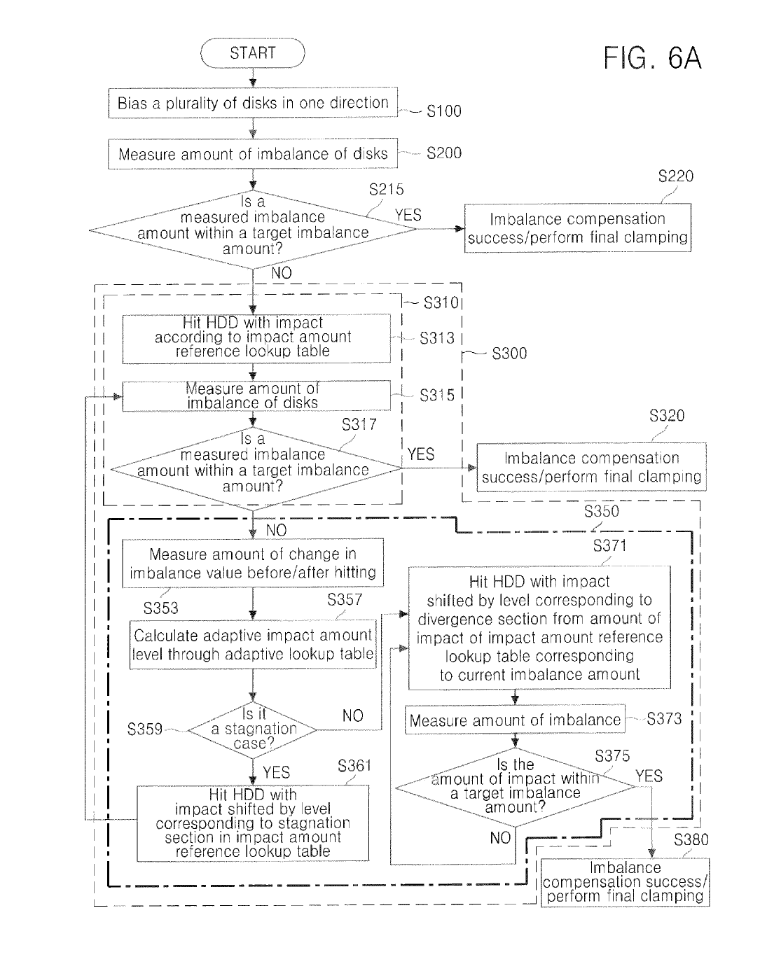

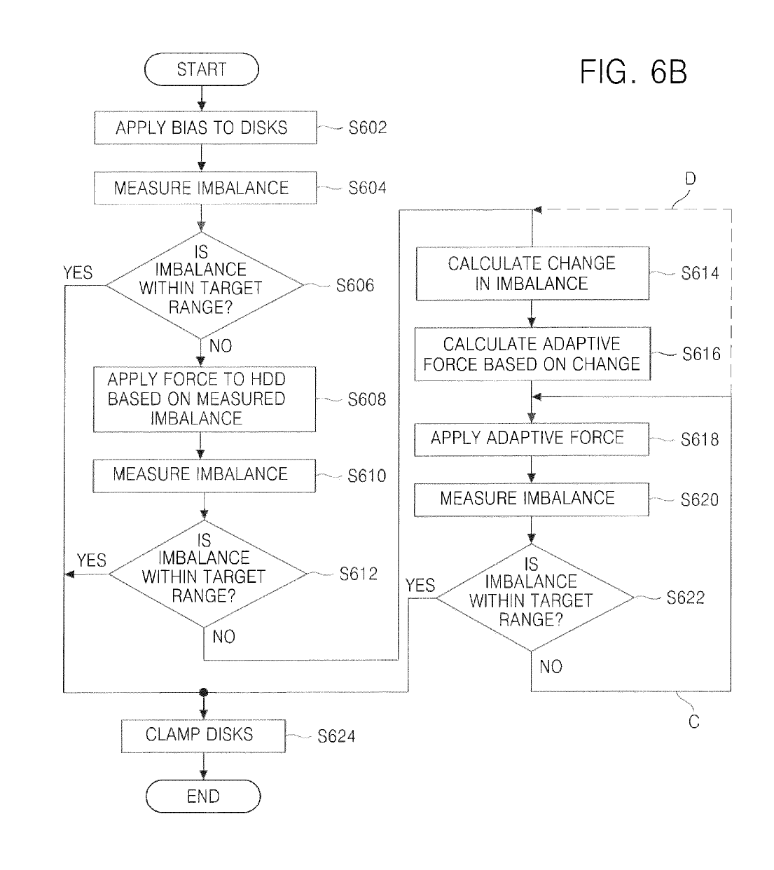

A method of compensating for imbalance of an HDD using the HDD imbalance compensation apparatus 100 according to an exemplary embodiment of the present general inventive concept will be described in detail. FIG. 6A is a flowchart illustrating such a method.

Referring to FIG. 6A, the method of compensating for imbalance of an HDD includes biasing the disks 11 mounted on the spindle motor hub 13a in one direction with respect to a rotational shaft of the spindle motor hub 13a (operation S100), measuring the amount of imbalance of the disks 11 that are biased with respect to the rotational shaft of the spindle motor hub 13a (operation S200), and compensating for the amount of imbalance by hitting the HDD 1 in the opposite direction to the direction in which the disks 11 are biased so that the amount of imbalance may be reduced with an amount of impact that is predetermined based on the measured amount of imbalance (operation S300).

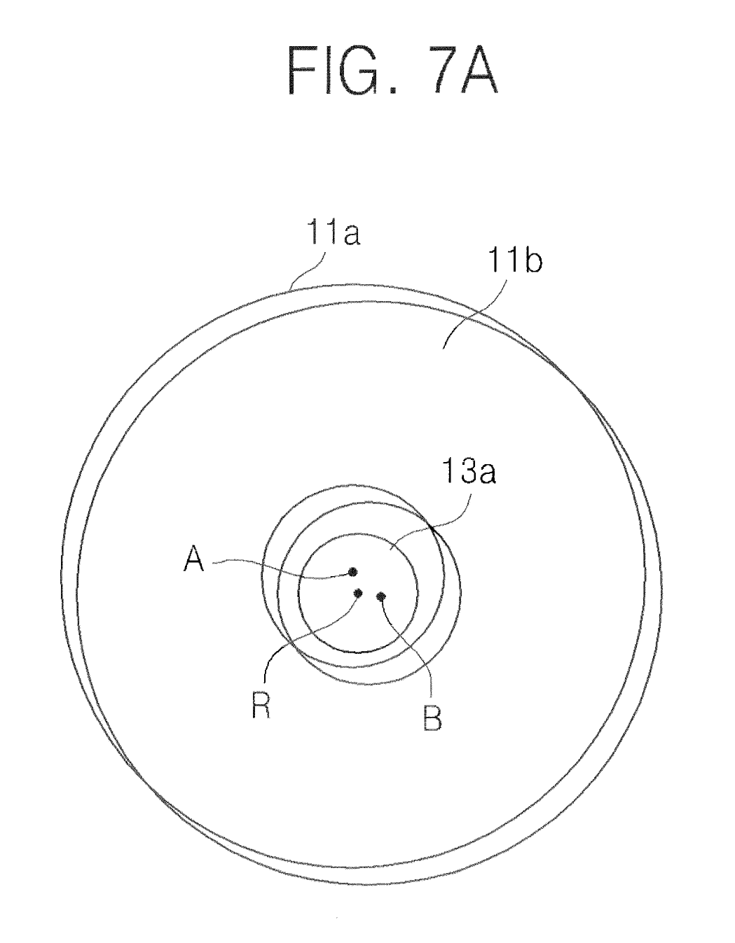

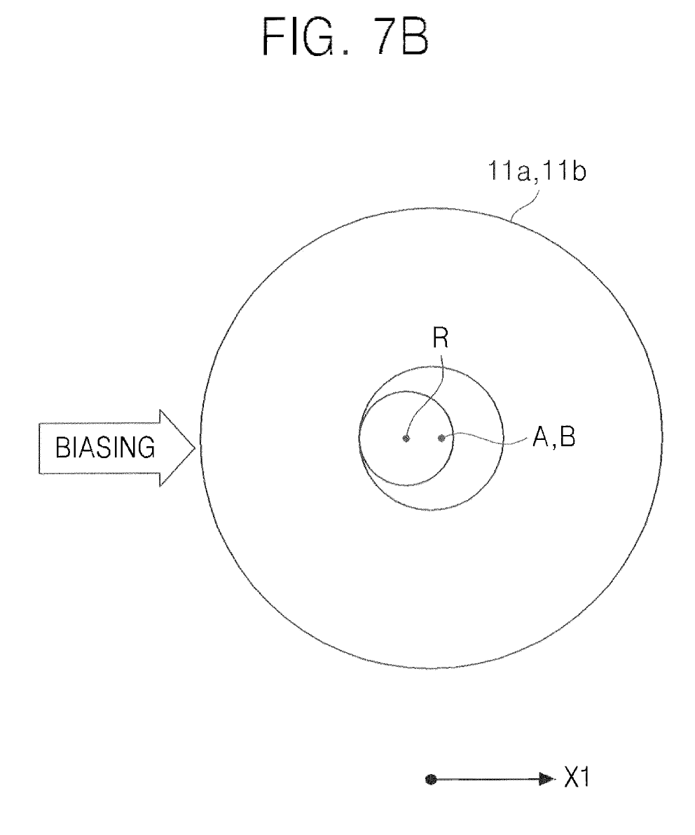

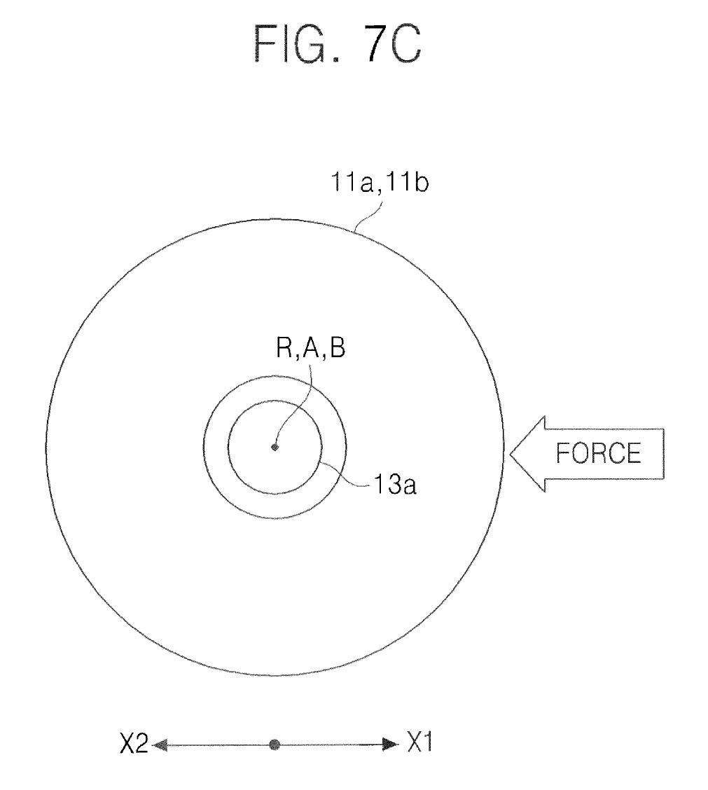

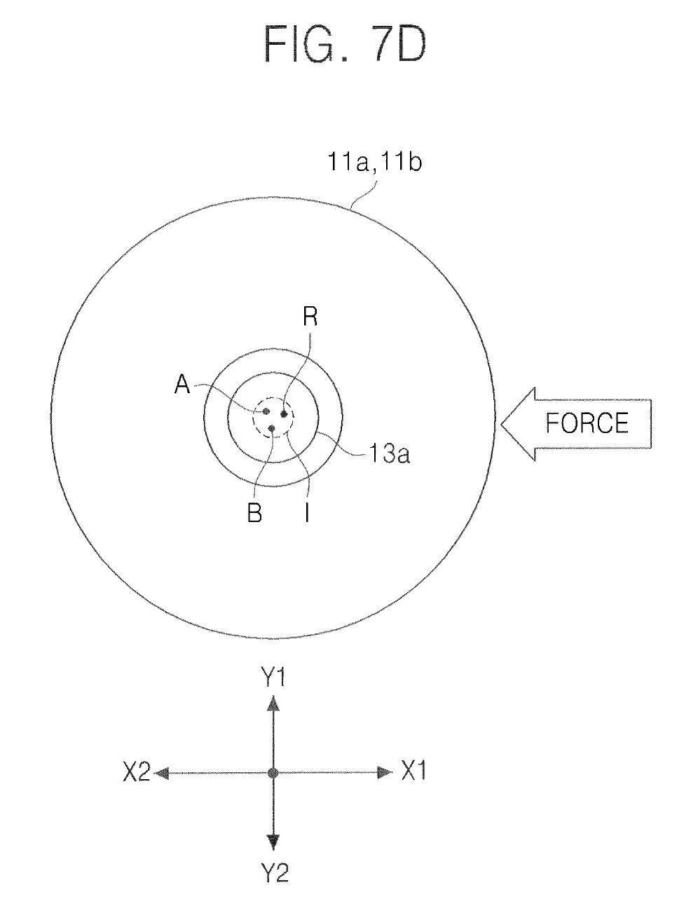

In the operation S100 of biasing the disks 11 in one direction, to facilitate the compensation of imbalance using an impact in the opposite direction to the direction in which the disks 11 are biased, the disks 11 are biased in one direction as illustrated in FIGS. 7A and 7B so that imbalance of the disks 11 may be aligned in the one direction at its maximum, and are temporarily coupled with an appropriate amount of coupling torque.

Referring to FIG. 7A, a plurality of disks 11a and 11b may have centers of weight or balance A and B that are different from each other and/or different from a center of rotation R of a spindle motor hub 13a. In the operation S100, the plurality of disks 11a and 11b may be pushed or moved in the same direction X1 so that each of the plurality of disks 11a and 11b is biased in a same direction with respect to the spindle motor hub 13a.

While FIG. 7B illustrates centers of balance A and B that are the same with respect to the disks 11a and 11b, the centers of balance A and B may be different for each of the plurality of disks 11a and 11b. After the biasing operation of S100, the centers of balance A and B of the disks 11a and 11b need not be in a precisely linear direction with respect to the center of rotation R of the spindle motor hub 13a. Instead, the centers of balance A and B may be in a substantially linear direction X1 with respect to the rotation center R. For example, each of the centers of balance may be located within a few degrees of the rotation center R with respect to the direction X1.

The temporary coupling in one direction may be performed by using a clamping jig that uses a static imbalance correction method in which the disks 11 and the spacer 12 are biased in the opposite directions to intentionally offset geometric biases.

When the operation S100 of biasing the disks 11 in one direction such that the imbalance positions of the disks 11 generating imbalance can be aligned in the one direction at its maximum is performed, a process of approaching the different imbalance positions of the disks 11 in a circumferential direction of the disks 11 by applying an impact to the HDD 1 may be omitted. Accordingly, in the hitting operation to compensate for the amount of imbalance, unnecessary hitting that produces less compensation effect may be minimized.

Thereafter, the operation S200 of measuring the amount of imbalance of the disks 11 that are biased, with respect to the rotation shaft of the spindle motor hub 13a, is performed. The amount of imbalance of the disks 11 with respect to the rotational shaft of the spindle motor hub 13a may be measured as the acceleration detection unit 150 of the HDD imbalance compensation apparatus 100 detects acceleration during the rotation of the disks 11.

In operation S215, it is determined whether the measured imbalance amount is within a target imbalance amount. For example, the target imbalance amount may include a range within which the imbalance of the HDD does not generate too much noise or would not damage the HDD during operation of the HDD. If the imbalance amount is within the target imbalance amount, in operation S220, final clamping of the HDD is performed to clamp the disks 11 in place with respect to the spindle motor hub 13a.

If, on the other hand, it is determined that the imbalance is outside the target imbalance amount, then the operation S300 is performed to compensate for the amount of imbalance of the disks 11 by hitting the HDD 1 in the opposite direction to the one direction in which the disks 11 are biased so that the amount of imbalance may be reduced with an amount of imbalance that is predetermined based on the measured amount of imbalance.

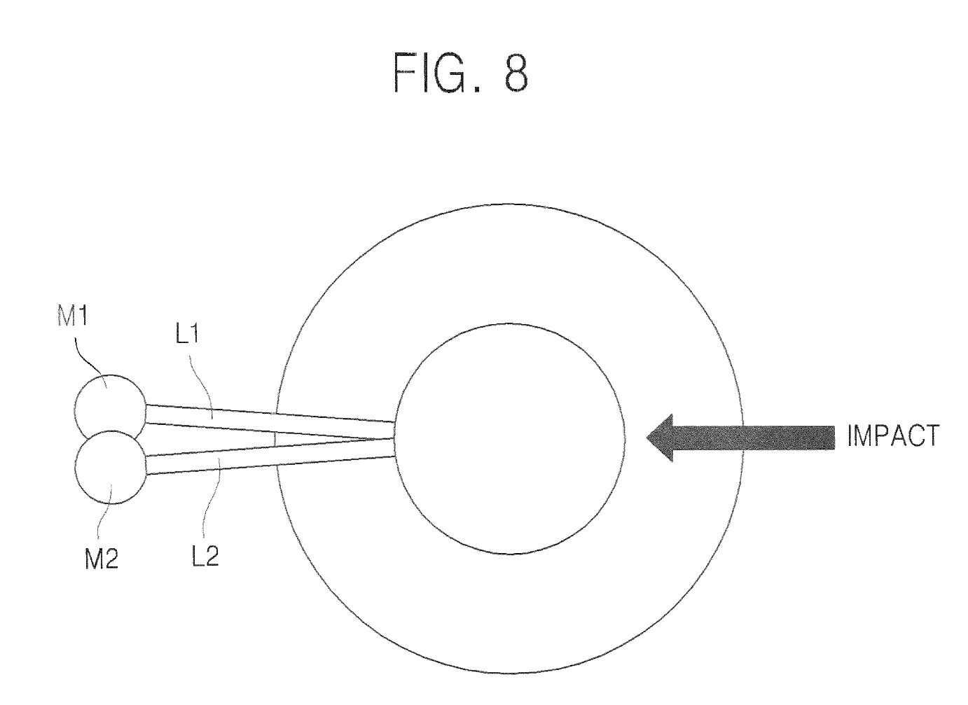

As shown in FIGS. 7C and 8, in operation S313, a force F is applied to the HDD 1 in a direction X2 opposite the direction X1. The force F moves the disks 11a and 11b in substantially the direction X2. However, although the disks 11a and 11b move in substantially the direction X2, differences in the centers of balance A and B of the disks 11a and 11b, differences in the friction between spacers 12 and the disks 11a and 11b, and other characteristics of the HDD 1 may cause the disks 11a and 11b to move in directions that are not precisely co-linear with the direction of force F.

FIG. 8 schematically illustrates an operation of compensating for the amount of imbalance by applying an impact to an HDD 1 in the opposite direction to the imbalance positions of the disks 11a and 11b. Referring to FIG. 8, in the regular compensation operation S310, an impact is applied to the HDD 1 in the opposite direction to the entire imbalance positions of the disks 11 with respect to the rotational shaft of the compensating the FIG. 8 schematically illustrates an operation of compensating the amount of imbalance by applying an impact to an HDD in the opposite direction to the imbalance positions of the spindle motor hub 13a with a corresponding amount of impact of the impact amount reference lookup table which will be described later, based on the measured amount of imbalance.

The imbalance positions L1 and L2 and imbalance masses M1 and M2 of the disks 11 are exaggerated for convenience of understanding and the imbalance masses M1 and M2 should not be interpreted to be actually applied to the disks 11.

FIG. 7D illustrates an example in which the centers of weight A and B of disks 11a and 11b, respectively, are not centered upon the rotation center R of the spindle motor hub 13a. Instead, a center of weight A of disk 11a is offset from the center R in the directions Y1 and X2. Similarly, the center of weight B of the disk 11b is offset from the center R in the directions Y2 and X2.

The circle I indicates a target range of imbalance that, if both of the centers of weight A and B are located within the circle I, would not adversely affect operation of the HDD. FIG. 7D illustrates a simplified acceptable range of imbalance, while the target range may vary. For example, a target range of imbalance may include one or more of an imbalance of each individual disk as well as a range of imbalance of the combination of all of the disks 11 of the HDD. In other words, the imbalance of the HDD may fall within the target range only if each disk falls within a predetermined range of imbalance and all the disks together fall within another range of imbalance. Alternatively, the sum of imbalances of all the disks 11 may be used, so that if one disk has a very low imbalance level, another disk may have a higher imbalance level, and the sum of the imbalances of the disks, or the average imbalance of the disks, may fall within the target range of imbalance.

The operation S300 of compensating for the amount of imbalance of the disks 11 includes a regular compensation operation (operation S310) and an adaptive compensation operation (operation S350). In the regular compensation operation S310, the HDD 1 is hit in operation S313 with the amount of impact that is predetermined based on the measured amount of imbalance. In the adaptive compensation operation S350, the amount of imbalance after the hitting of the HDD 1 is measured and the HDD is hit with an amount of impact that is predetermined based on an amount of a change in the amount of imbalance before and after the hitting.

In other words, in the regular compensation operation S310, the amount of force used to impact the HDD 1 is based on the measured imbalance level of the disks 11. However, in the adaptive compensation operation S350, the amount of force used to impact the HDD1 is not based upon the absolute measured imbalance level of the disks 11 of operation S200, but upon the difference between the initially measured imbalance level of operation S200 and the level of imbalance after the HDD 1 is hit in operation S313.

TABLE 1

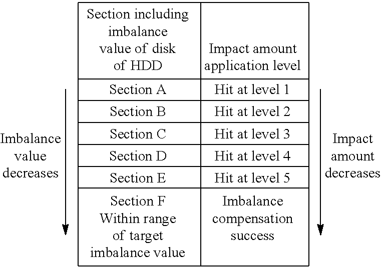

The amount of impact applied to the HDD 1 in the regular compensation operation S310 is determined according to an impact amount reference lookup table shown in Table 1. The impact amount reference lookup table includes impact amount application levels used to compensate for each of imbalance levels according to a model characteristic of the HDD 1. The amount of imbalance decreases from “Section A” to “Section F”, whereas the amount of impact applied to the HDD 1 decreases from “Level 1” to “Level 5”. However, the right scope of the present general inventive concept is not limited thereto and the impact amount reference lookup table of Table 1 is merely an example and more or less number of sections may be set according to a situation.

After an impact is applied to the HDD 1 in operation S313, an operation of measuring the amount of imbalance of the disks 11 is performed in operation S315. Then, an operation of determining whether the amount of imbalance after the hitting of the HDD 1 belongs to a target imbalance amount is performed in operation S317.

When the amount of imbalance after the hitting of the HDD 1 corresponds to the target imbalance amount, the imbalance of the disks 11 is determined to be compensated so that the disks 11 are finally or permanently clamped in operation S320. For example, the clamp 15 may be affixed to the spindle motor hub 13a with a screw, adhesive, or other fixing devices to fix the disks 11 with respect to the spindle motor hub 13a. When the amount of imbalance after the hitting of the HDD 1 does not belong to the target imbalance amount, the adaptive compensation operation S350 of hitting the HDD 1 with the amount of impact predetermined based on an amount of a change in the amount of imbalance after and before the hitting is performed. Since the hitting process cannot be performed endlessly, it is determined whether the number of trials reaches a limit. When the number of trials reaches a limit, even if the number of trials does not belong to a target imbalance amount, the imbalance compensation may not be performed any more.

In the adaptive compensation operation S350, an operation of measuring an amount of a change in the amount of imbalance is performed (operation S353). In the operation S353 of measuring an amount of a change in the amount of imbalance, a relative amount of a change in the amount of imbalance before and after the hitting with the amount of impact of the impact amount reference lookup table according to the amount of imbalance is measured by using the following equation.

$$An amount of change = \frac{\begin{matrix}Amount of imbalance before hitting - \\ Amount of imbalnce after hitting\end{matrix}}{\begin{matrix}Lower limit of section corresponding to \\ the amount of imbalance before hitting\end{matrix}} \qquad [ Equation 1 ]$$

However, the scope of the present general inventive concept is not limited thereto and various equations for measuring a relative amount of a change may be used.

After the amount of a change in the amount of imbalance before and after the hitting is calculated according to Equation 1, it is determined in operation S359 based on the amount of a change in the amount of imbalance whether the amount of imbalance after the hitting increases compared to the amount of imbalance before the hitting (a divergence case) or whether the amount of imbalance after the hitting decreases compared to the amount of imbalance before the hitting (a stagnation case). Then, in operation S361, the HDD 1 is hit with a force having a predetermined strength or intensity according to whether the divergence case, the stagnation case, or the stagnation case is applicable.

In particular, in the adaptive compensation operation S350, a method of applying an impact of a variable amount is employed in which, when a relative change amount is compared with a reference change amount in the adaptive lookup table of a corresponding model, it is determined in operation S353 whether a friction characteristic of the HDD 1 is above or under the standard and an imbalance compensation profile is generated or accessed so that a stronger or weaker force may be applied in a subsequent hitting operation S353. Thus, an imbalance compensation profile that is adapted to the HDD 1 is provided so that an HDD 1 having a high imbalance amount may be adjusted so that the imbalance amount is less than a target imbalance amount. Since a different compensation profile may be used for different HDD's in a production line, for example, the HDD's may be quickly adjusted to within the target imbalance value.

To this end, in the adaptive compensation operation S357, an adaptive impact amount level is calculated according to an adaptive lookup table as shown in Table 2. The adaptive lookup table may include different levels of force to correspond to different levels of changes in imbalance due to the application of force to the HDD1. The different levels of force may correspond to the divergence case, the stagnation case, or a degree of the stagnation case. Then, in operation S361, the HDD 1 is hit with the amount of impact determined by the reference lookup table.

In the present exemplary embodiment, for a stagnation case, the adaptive compensation operation S350 is repeated until the amount of imbalance reaches a target imbalance amount or a predetermined frequency is reached. In addition, for a divergence case, the adaptive compensation operation S350 is repeated until the amount of imbalance reaches a target imbalance amount or a predetermined frequency is reached. Once the change in imbalance is determined and the applicable level of force is determined in Table 2 to correspond to a stagnation case, such as in Section A, Section B, or Section C, the level of force determined in Table 2 may be repeatedly applied without further measuring the amount of change in the imbalance in operation S353. In other words, the imbalance may be measured after each application of the determined level of adaptive force until the level of imbalance is within the target level of imbalance. After the calculation of the correct adaptive force of the Table 2, the adaptive force may be repeatedly applied without again referring to the Table 2.

TABLE 2

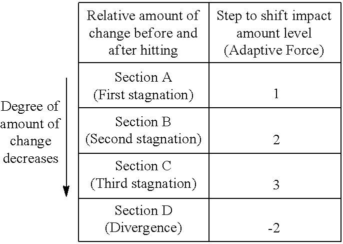

In case of the stagnation case, Table 2 shows an adaptive lookup table used in the adaptive compensation operation S350. In the adaptive lookup table of Table 2, the amount of a change in the amount of imbalance decreases from “Section A” to “Section C”, which means the friction characteristic of the HDD 1 is strong so that hitting with a stronger impact is needed.

In particular, when a section corresponds to a smaller degree of change of imbalance, the friction characteristic may be strong between the disks 11 and the spacers 12, and thus it may be difficult to adjust the HDD 1 to compensate for the imbalance. Accordingly, the HDD 1 needs to be hit with a stronger impact. For example, when the amount of a change corresponds to “Section B”, the HDD 1 is hit with an amount of impact that is twice as strong as a corresponding amount of impact in the impact amount reference lookup table of Table 1.

A strong impact force needs to be applied when an imbalance compensation stagnation phenomenon, which is often generated when a friction characteristic is strong due to allowance in parts during mass production, occurs. Although the amount of a change may be large at a high imbalance level, it may be stagnant at a low level so that the amount of a change is measured at each hitting and it is determined how strong of an impact force is needed by shifting levels from the adaptive lookup table.

After the adaptive compensation operation S350 is performed, an operation of measuring the amount of imbalance of the disks 11 is performed in operation S315. If the amount of imbalance of the disks 11 after hitting belongs to a target imbalance amount, the imbalance compensation is regarded to be achieved and thus an operation of performing final clamping is performed in operation S320. Otherwise, an operation of measuring the amount of a change in the amount of imbalance is performed again in operation S353.

In the above-described stagnation case, the adaptive compensation operation is repeatedly performed until the amount of imbalance of the disks 11 corresponds to a target imbalance amount range.

In the meantime, for a divergence case, the adaptive compensation operation may be repeatedly performed until the amount of imbalance reaches a target imbalance amount or a predetermined frequency is reached, continuously with the amount of impact of the impact amount reference lookup table shifted by a level corresponding to a stagnation section of the adaptive lookup table from the impact amount reference lookup table corresponding to a current imbalance amount.

“Section D” of Table 2 shows a negative change amount in which, although a hitting force according to the impact amount reference lookup table is applied, the amount of imbalance is not compensated for, but it rather increases. Accordingly, the HDD 1 may be hit with an amount of impact two levels weaker than the amount of impact corresponding to the impact amount reference lookup table of Table 1 by referring to a current imbalance amount. That is, a weak hitting force is applied to an imbalance compensation divergence phenomenon that is often generated because a friction characteristic is weak due to allowance in parts during mass production, and consequently, applying a strong force may cause the disks 11 to rebound back in a direction X opposite the direction in which the force F is applied.

Once a negative amount of a change is detected, unlike the imbalance compensation stagnation phenomenon, adaptive hitting is not performed by measuring the amount of a change for each hitting, that is, the adaptive compensation operation is not repeated, but a hitting force that is weaker by two levels of a corresponding imbalance amount may be continuously applied from a subsequent hitting operation until a target imbalance amount is achieved. This is because, when the measured imbalance value does not indicate an eccentric direction, a case that is divergent in the opposite direction to a direction in which imbalance is generated may be considered to be a stagnation phenomenon.

When the imbalance is compensated with the amount of a change greater than “Section A” of Table 2, adaptive hitting is not applied and hitting is performed according to the impact amount reference lookup Table 1. The impact amount reference lookup table of Table 2 may be diversely provided according to a situation and a model as in Table 1.

FIG. 6B illustrates a method of compensating for an imbalance of disks in an HDD according to another embodiment of the present general inventive concept.

Similar to FIG. 6A, in operation S602 of FIG. 6B, the disks of the HDD may receive a biasing force to bias the disks in the same direction, as illustrated in FIG. 7B. In operation S604, the imbalance level of the HDD may be measured. This may be performed by measuring the imbalance of the entire HDD, of only the disks of the HDD, or of each respective disk of the HDD. The imbalance may be measured by rotating the disks and measuring variations in rotation patterns, by piezo-electric sensors connected to the HDD, or by any other sensor or means of determining imbalance.

In operation S606, it is determined whether the imbalance of the disks falls within a target range. The target range may apply to a range in which the imbalance will not adversely affect operation of the HDD, for example. If the measured imbalance falls within the target range, then the disks may be fixed to the spindle motor hub of the HDD, by a clamp or adhesive, for example, in operation S624. It should be understood that any method may be used to fix the disks to the spindle motor hub to allow the disks to rotate with respect to a frame or base of the HDD 1.

If it is determined in operation S606 that the measured imbalance is not within the predetermined range, a jolting or impact force may be applied to the HDD in operation S608, as illustrated in FIGS. 7C and 8, for example. The force may be applied with the HDD imbalance compensation apparatus of FIG. 3, for example. The jolting force may be determined by performing a calculation, accessing a pre-stored table from memory, or by any other method.

Upon applying the jolting force in operation S608, the imbalance of the disks or the HDD is again measured in operation S610, and it is again determined in operation S612 whether the measured imbalance falls within the target range of an acceptable level of imbalance.

If the measured level of imbalance still does not fall within the target range, then the change in imbalance between the measured imbalance (operation S604) before the jolting force is applied and the measured imbalance (operation S610) after the jolting force is applied is calculated in operation S614. An adaptive jolting force may be calculated in operation S616 based on the calculated change in imbalance. The adaptive jolting force may be calculated by applying an equation, referring to pre-stored jolting force values in a table, or by applying pre-stored values of a table (such as Table 2) to the jolting force value of operation S608 to generate a different, adaptive jolting force value.

The adaptive jolting force may be applied to the HDD in operation S618 and the imbalance may be measured in operation S620. If it is determined in operation S622 that the measured imbalance does not fall within the target range, then the adaptive jolting force may be repeatedly applied, and the imbalance may be repeatedly measured, until the measured imbalance is within a predetermined range. The adaptive jolting force may be repeatedly applied without re-calculating the change in imbalance, as indicated by the solid line C in FIG. 6B. Alternatively, the change in imbalance between the present imbalance and either the immediately preceding imbalance or the originally-measured imbalance (operation S604) may be repeatedly calculated, as indicated by the dashed line D in FIG. 6B.

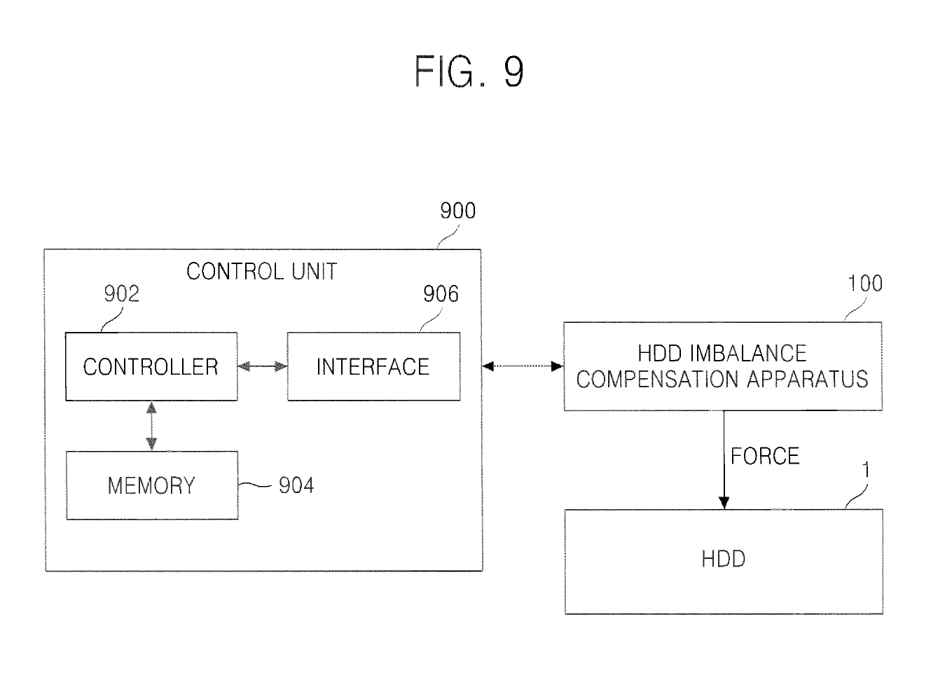

FIG. 9 illustrates a block diagram of an HDD imbalance compensation system or device according to an embodiment of the present general inventive concept. An HDD 1 may be mounted to the HDD imbalance compensation apparatus 100, as described above. The HDD imbalance compensation apparatus 100 may detect the imbalance of the HDD1 or disks of the HDD1, and may apply a jolting force or impact to the HDD1 to shift the location of the disks of the HDD1 with respect to a spindle motor hub of the HDD 1.

The HDD imbalance compensation unit 100 communications with a control unit 900 to transmit detected imbalance values and to receive commands. The control unit 900 and HDD imbalance compensation apparatus 100 may be part of a same device. For example, they may be located within the same body, shell, or frame. Alternatively, the control unit 900 may be a separate device, such as a host computer or terminal, and may be connected to the HDD imbalance compensation apparatus 100 via one or more data lines to communicate with the HDD imbalance compensation apparatus 100.

The control unit 900 may include an interface 906 to transmit and receive data, a controller 902 to perform calculations and execute commands, and memory 904 to store data. The memory 904 may store equations and tables for example. The controller 902 may receive imbalance data from the HDD imbalance compensation apparatus 100 and may access the equations or tables stored in memory 904 to calculating a jolting or impact force to be applied to the HDD 1. The controller 902 may transmit commands to the HDD imbalance compensation apparatus 100 to apply a jolt or impact of a predetermined intensity to the HDD 1.

The controller 902 may include a processor, memory, logic circuits, an arithmetic logic unit, or any other devices. The memory 904 may be part of the controller 902 or may be a separate device or component, as illustrated in FIG. 9. The interface 906 may include one or more physical interface ports to connect wires, or may include a wireless interface, such as an antenna.

TABLE 3

| | Compensation | | | Number of | | |
|---|---|---|---|---|---|---|
| | success rate | | | occurrence | Success rate | |
| Biasing in one | 45% | 19/40 | Stagnation | 15/40 → | 4/15 | 27% |
| direction of | | | Divergence | 1/40 → | 0/1 | 0% |
| disk not | | | | | | |
| applied/ | | | | | | |
| Adaptive | | | | | | |
| compensation | | | | | | |
| method not | | | | | | |
| applied | | | | | | |
| Biasing in one | 70% | 28/40 | Stagnation | 3/40 → | 2/3 | 67% |
| direction of | | | Divergence | 4/40 → | 2/4 | 50% |
| disk applied/ | | | | | | |
| Adaptive | | | | | | |
| compensation | | | | | | |
| method not | | | | | | |
| applied | | | | | | |
| Biasing in one | 98% | 39/40 | Stagnation | 6/40 → | 5/6 | 83% |
| direction of | | | Divergence | 6/40 → | 6/6 | 100% |
| disk applied/ | | | | | | |
| Adaptive | | | | | | |
| compensation | | | | | | |
| method applied | | | | | | |

Table 3 shows data in comparison between a case in which the method of compensating for imbalance of the disks 11 of the HDD 1 according to the present general inventive concept is applied and a case in which the method for compensating for imbalance of the disks 11 of the HDD 1 is not applied. When a case in which both of biasing before hitting and an adaptive compensation method are not applied, a case in which biasing before hitting is applied but an adaptive compensation method is not applied, and a case in which both of biasing before hitting and an adaptive compensation method are applied are compared with one another, the case of applying both of biasing before hitting and an adaptive compensation method shows a remarkably high imbalance success rate.

While the operation S300 of compensating for the amount of imbalance of the disks 11 is performed, a scratch pattern is formed on the disks 11. The scratch pattern of the disks 11 of the present exemplary embodiment is formed in the same direction when checked with the bare eyes because the disks 11 are biased in one direction in an assembly process of the HDD 1 so as to generate eccentricity. Since imbalance is compensated by various hitting forces in consideration that the friction characteristics of the HDD 1 are different from one another due to allowance in parts, a pattern having scratches of various sizes is formed.

As described above, according to the present inventive concept, since the disks 11 are biased in one direction and the HDD 1 is hit in the opposite direction to the one direction, unnecessary hitting may be remarkably reduced when imbalance of the HDD 1 is compensated. Thus, a tact time is reduced so that mass production may be facilitated.

Also, since imbalance may be compensated according to an individual characteristic of the HDD 1 by hitting the HDD 1 with an amount of impact predetermined based on the amount of a change in the amount of imbalance before and after hitting, a compensation success rate increases and a process time is reduced so that mass production may be facilitated.

In the present exemplary embodiment, when an amount of impact predetermined based on the amount of a change in the amount of imbalance before and after hitting is calculated, an adaptive lookup table is used to calculate an amount of impact of an impact amount reference lookup table shifted by a level corresponding to a stagnation section or a divergence section of the adaptive lookup table from the impact amount reference lookup table corresponding to a current imbalance amount. However, another type of an adaptive lookup table that may directly determine the amount of impact for hitting the HDD 1 in a stagnation section or a divergence section of the adaptive lookup table based on a current imbalance amount may be used instead.

While the general inventive concept has been particularly shown and described with reference to exemplary embodiments thereof, it will be understood that various changes in form and details may be made therein without departing from the spirit and scope of the following claims.

What is claimed is:

1. A method of compensating for an imbalance of a hard disk drive, the method comprising:
biasing a plurality of disks in a first direction with respect to a rotational shaft of a spindle motor hub, the plurality of disks being mounted on the spindle motor hub;
measuring an amount of imbalance of the plurality of disks that are biased with respect to the rotational shaft of the spindle motor hub; and
compensating the amount of imbalance of the plurality of disks by hitting the hard disk drive in a second direction opposite the first direction to reduce the amount of imbalance with an amount of impact predetermined based on a measured imbalance amount.

2. The method of claim 1, wherein the compensating of the amount of imbalance of the plurality of disks comprises:
performing a regular compensation operation by hitting the hard disk drive a first time with an amount of impact predetermined based the measured imbalance amount; and
performing an adaptive compensation operation by measuring an amount of imbalance after the first hitting of the hard disk drive and hitting the hard disk drive a second time with an amount of impact predetermined based on an amount of a change in the amount of imbalance before and after the first hitting.

3. The method of claim 2, wherein the amount of force with which to hit the hard disk drive the first time is determined according to an impact amount reference lookup table containing values predetermined corresponding to the amount of imbalance.

4. The method of claim 3, wherein the adaptive compensation operation comprises determining whether the change in the amount of imbalance indicates a divergence case in which the amount of imbalance increases after the hitting or a stagnation case in which the amount of imbalance decreases after the hitting, and
the hard disk drive is hit again with an amount of impact previously set according to the determined change in imbalance.

5. The method of claim 4, wherein the hard disk drive is hit the second time with an amount of impact of the impact amount reference lookup table shifted from the impact amount reference lookup table according to an adaptive lookup table containing a level to be shifted from the impact amount reference lookup table according to the determined change in imbalance.

6. The method of claim 5, wherein, in the stagnation case, the adaptive compensation operation is repeatedly performed until the amount of imbalance reaches a target imbalance amount or a predetermined frequency is reached.

7. The method of claim 5, wherein, in the divergence case, the hard disk drive is repeatedly hit with the amount of impact of the impact amount reference lookup table shifted from the impact amount reference lookup table according to the adaptive lookup table until the amount of imbalance reaches a target imbalance amount or a predetermined frequency is reached.

8. A method of compensating imbalance of a hard disk drive, the method comprising:
measuring an amount of imbalance of a plurality of disks with respect to a rotational shaft of a spindle motor hub, the plurality of disks being mounted on the spindle motor hub;
performing a regular compensation operation by hitting the hard disk drive a first time with an amount of impact predetermined based a measured imbalance amount; and
performing an adaptive compensation operation by measuring an amount of imbalance after the hitting of the hard disk drive and hitting the hard disk drive a second time with an amount of impact predetermined based on an amount of a change in the amount of imbalance before and after the first hitting.

9. The method of claim 8, wherein, in the regular compensation operation, the amount of impact to hit the hard disk drive the first time is determined according to an impact amount reference lookup table containing values predetermined corresponding to the amount of imbalance.

10. The method of claim 9, wherein the adaptive compensation operation comprises determining whether a measured change in the imbalance after the first hitting indicates a divergence case in which the amount of imbalance increases after the first hitting or a stagnation case in which the amount of imbalance decreases after the first hitting, and
the hard disk drive is hit the second time with an amount of impact previously set according to the divergence case or the stagnation case, respectively.

11. The method of claim 10, wherein the hard disk drive is hit the second time with an amount of impact of the impact amount reference lookup table shifted from the impact amount reference lookup table according to an adaptive lookup table containing a level to be shifted from the impact amount reference lookup table according to the divergence case or the stagnation case, respectively.

12. The method of claim 11, wherein, in the stagnation case, the adaptive compensation operation is repeatedly performed until the amount of imbalance reaches a target imbalance amount or a predetermined frequency is reached.

13. The method of claim 11, wherein, in the divergence case, the hard disk drive is repeatedly hit with the amount of impact of the impact amount reference lookup table shifted from the impact amount reference lookup table according to the adaptive lookup table until the amount of imbalance reaches a target imbalance amount or a predetermined frequency is reached.

14. A hard disk drive comprising:
a spindle motor hub provided on a base; and
a plurality of disks mounted on the spindle motor hub and on which a scratch pattern is formed in the same direction.

15. A method of compensating for an imbalance of disks of a hard disk drive, the method comprising:
measuring an imbalance of the disks of the hard disk drive;
applying a jolting force to the hard disk drive based on the measured imbalance;
measuring a change in imbalance after applying the jolting force to the hard disk drive, the change being a difference between the imbalance before applying the jolting force and the imbalance after applying the jolting force;
calculating an adaptive jolting force to apply to the hard disk drive based on the measured change in imbalance; and
applying the adaptive jolting force to the hard disk drive.

16. The method of claim 15, further comprising:
before measuring the imbalance of the disks, biasing each of the disks in the same direction with respect to a spindle motor hub on which the disks are mounted.

17. The method of claim 15, wherein measuring the imbalance of the disks includes rotating the disks and detecting the imbalance of the rotating disks.

18. The method of claim 15, wherein applying the jolting force includes accessing a table having a plurality of imbalance ranges and a plurality of corresponding jolting forces, matching the measured imbalance with one of the plurality of imbalance ranges, and applying the corresponding jolting force.

19. The method of claim 15, wherein measuring the change in imbalance after applying the jolting force includes applying the following formula:
$$\frac{\begin{matrix}imbalance before applying jolting force - \\ imbalance after applying jolting force\end{matrix}}{\begin{matrix}lower limit of matched one \\ of the plurality of imbalance ranges\end{matrix}} .$$

20. The method of claim 15, wherein calculating the adaptive jolting force includes accessing an adaptive jolting force table including a plurality of ranges of change in imbalance and a corresponding plurality of adjustment values, matching the measured change in imbalance with one of the plurality of ranges, and applying the corresponding adjustment value to the jolting force to generate an adaptive jolting force.

21. The method of claim 15, wherein applying the adaptive jolting force to the hard disk drive includes repeatedly applying the adaptive jolting force to the hard disk drive and measuring the imbalance of the hard disk drive until the measured imbalance is within a target range.

22. The method of claim 21, wherein the adaptive jolting force is repeatedly applied to the hard disk drive without re-calculating the adaptive jolting force.
